(19) United States
(12) Patent Application Publication
(10) Pub. No.: US 2013/0283815 A1
(43) Pub. Date: Oct. 31, 2013

(54) INTEGRAL COOLING FOR SERVO VALVE

(71) Applicant: Scott W. Simpson, Easthampton, MA (US)

(72) Inventor: Scott W. Simpson, Easthampton, MA (US)

(73) Assignee: HAMILTON SUNDSTRAND CORPORATION, Windsor Locks, CT (US)

(21) Appl. No.: 13/456,680

(22) Filed: Apr. 26, 2012

(51) Int. Cl. F02C 7/18; F16K 49/00

(52) U.S. Cl. 60/782; 137/338; 60/806

(57) ABSTRACT

A cooling structure for a servo valve includes a shroud to enclose at least a portion of the servo valve; and a base connected to the shroud to define a cooling chamber surrounding the servo valve, the base including an inlet port to receive cooling air, a flow channel connecting to the inlet port and a plurality of flow passages connecting the flow channel to the cooling chamber to allow cooling air flow from the inlet port into the cooling chamber.

### BACKGROUND

This invention relates generally to valves, and specifically to servo valves.

Gas turbine engines typically include bleed systems for bleeding off air from the engine. This air is typically very hot, 500 degrees F. (260 degrees C., 533.15 K) or more, so components of the system must be able to withstand these temperatures. Valves in bleed system typically include a servo valve that can include electronics sensitive to the high temperatures. Because of this, the servo valve is sometimes remotely mounted away from the valve and high temperatures.

### SUMMARY

A cooling structure for a servo valve includes a shroud to enclose at least a portion of the servo valve; and a base connected to the shroud to define a cooling chamber surrounding the servo valve, the base including an inlet port to receive cooling air, a flow channel connecting to the inlet port and a plurality of flow passages connecting the flow channel to the cooling chamber to allow cooling air flow from the inlet port into the cooling chamber.

A method of cooling a portion of a servo valve with electrical components includes providing a servo valve with a portion with electrical components; providing a cooling structure with a shroud with a vent port and a base, the base with an inlet port to receive cooling air, a flow channel connecting to the inlet port and a plurality of flow passages connecting the flow channel to the shroud to allow cooling air flow into the shroud; connecting the base to the portion of the servo valve with electrical components; and connecting the shroud to the base to form a cooling air cavity around the portion of the servo valve with electrical components.

### BRIEF DESCRIPTION OF THE DRAWINGS

FIG. 1 shows a perspective view of a servo valve.

FIG. 2A shows a perspective view of a cooling structure for a portion of the servo valve of FIG. 1.

FIG. 2B shows a bottom view of the cooling structure of FIG. 2A.

FIG. 2C shows a cross-sectional view of the cooling structure of FIG. 2A.

### DETAILED DESCRIPTION

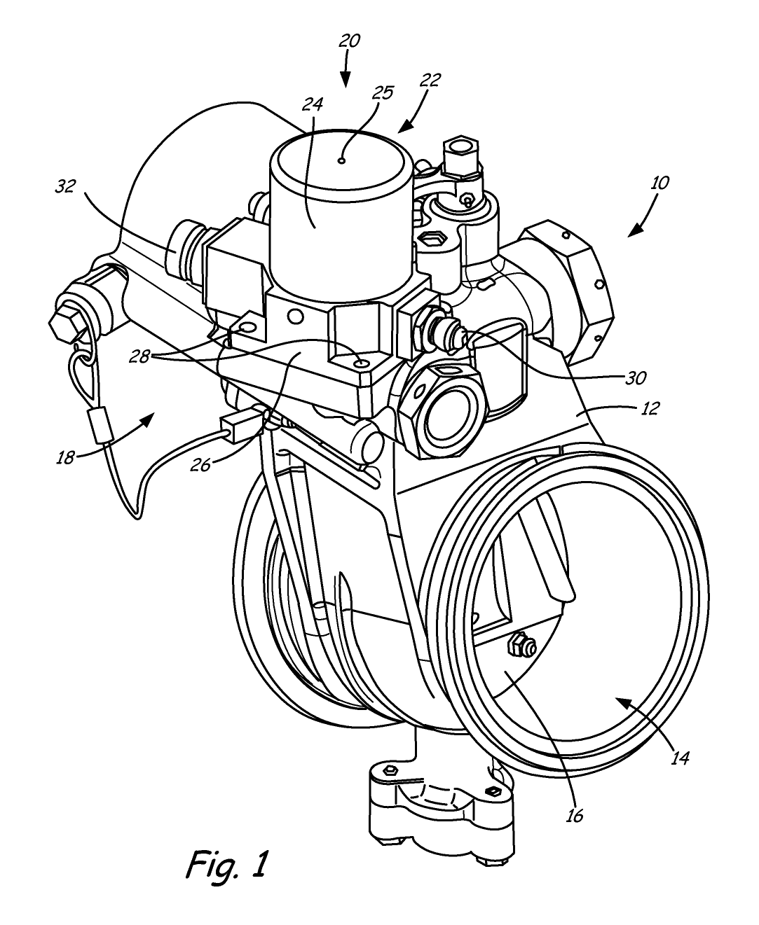

FIG. 1 shows a perspective view of valve 10 with valve body 12, valve passage 14, valve disk 16, actuator 18, servo valve 20 and cooling structure 22 with shroud 24 (with vent port 25) and base 26 (with bolts 28, inlet port 30 and electrical connector 32). Valve 10 can be part of a bleed system on a gas turbine engine.

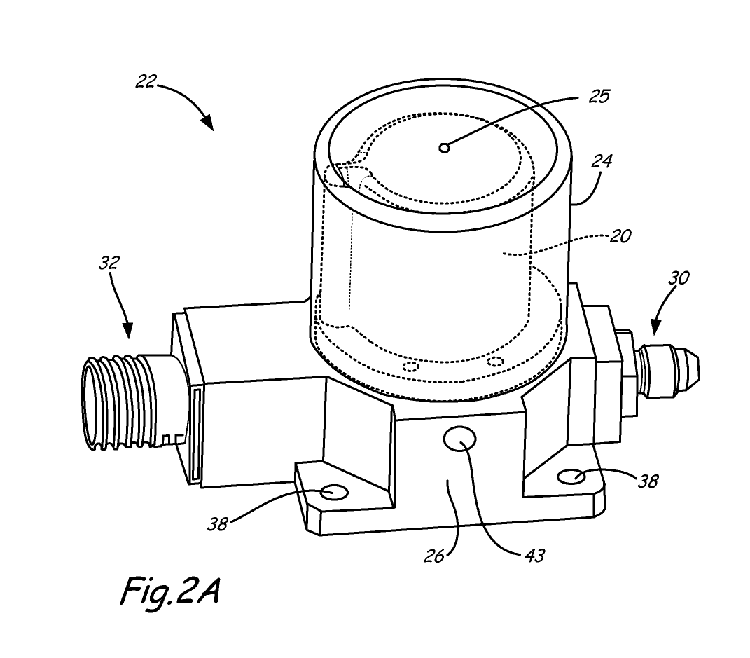

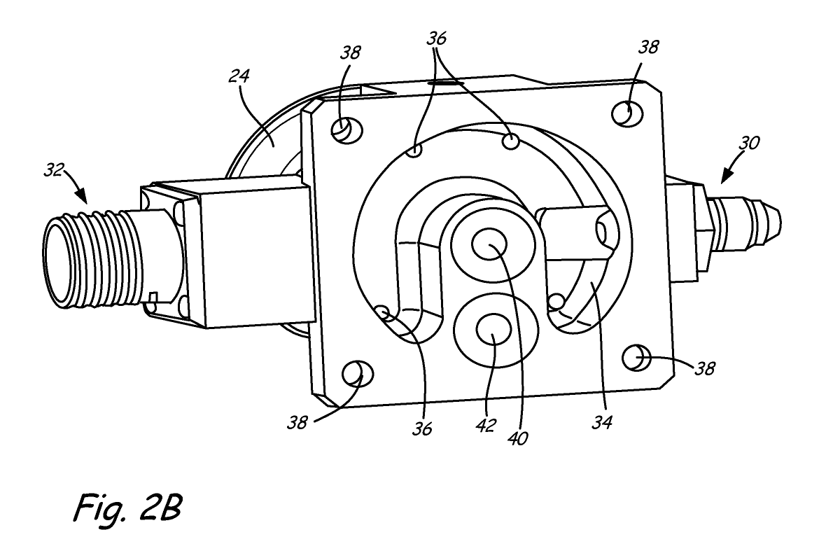

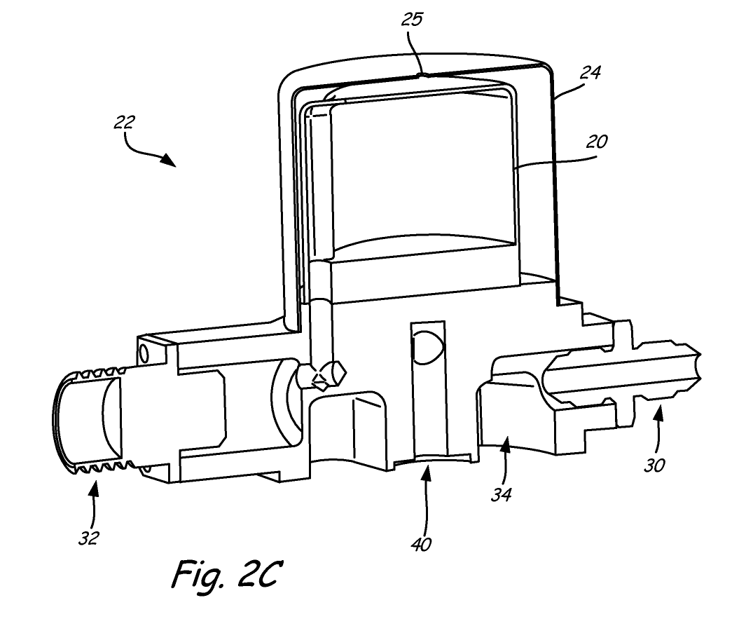

Valve disk 16 sits in valve passage 14 and connects to actuator 18. Actuator 18 is connected to and controlled by servo valve 20. Servo valve 20 includes base 26, which forms a part of cooling structure 22. Cooling structure 22 can be integral to servo valve 20. Actuator can include pressure ports (see FIG. 2B), one or more pistons and a linkage system (not shown) to connect to valve disk 16. Servo valve 20 receives electronic signals from a controller (not shown) through wires connected to electrical connector 32 to control air in pressure ports. The pressure in pressure ports causes actuator to open or close valve 10 by rotating valve disk 16, opening or closing valve 10.

Cooling structure 22 includes shroud 24 which connects to base 26 and encloses servo valve 20 to form a cooling chamber around servo valve 20. Cooling structure 22 can be bolted to valve body 12 with bolts 28. Inlet port 30 on base 26 receives a cooling airflow. In a bleed system on a gas turbine engine, this cooling flow can come from the fan and can be delivered by a thermal line (not shown).

Air in the pressure ports typically comes from valve passage 14, and when valve passage 14 is part of a bleed system, this air can be very hot, for example, 1200 degrees F. (649 degrees C., 922.15 K). The electrical components of servo valve 20 typically are not built to handle such high temperatures and may be susceptible to melting or servo valve failure if exposed. Past systems have prevented failure of electrical components in the servo valve by locating the servo valve away from the valve body and connecting it to the actuator with different linkage lines and components. In some past systems, the electrical components were bolted to a fan casing, which was six feet or more away from the valve. This resulted in additional components for the valve, increasing the weight and space which the valve needed. A second method of avoiding the melting and failure of electrical components was to direct a cooling flow at the electrical components. This proved to be an inefficient and oftentimes ineffective way of cooling.

Cooling structure 22 provides for effective and efficient cooling of electrical components of servo valve without the need for much increased space and weight of past cooling systems. Cooling structure 22 receives cooling air through inlet port 30, circulates the cooling air close to servo valve 20 by forming a cooling chamber with base 26 and shroud 24, and then vents that cooling air out vent port 25 to keep a continuous flow.

FIG. 2A shows a perspective view of cooling structure 22 for a portion of the valve 10, FIG. 2B shows a bottom view of cooling structure 22, and FIG. 2C shows a cross-sectional view of cooling structure 22 of FIG. 2A. Cooling structure 22 includes shroud 24 with vent port 25 and base 26 with inlet port 30, electrical connector 32, flow channel 34, flow passages 36, holes 38 for bolts 28, control pressure port 40, supply pressure port 42 and ambient vent for servo valve 43. Servo valve 20 inner workings are not shown, and only the outer housing is illustrated in FIGS. 2A-2C.

Cooling structure 22 can be made of aluminum, steel or other materials that can withstand high temperatures and contain cooling air flow. Shroud 24 can be flat on a top portion with a cylindrical side wall connecting to base 26 to form a sealed cavity or chamber around servo valve 20. The connection can include screwing shroud 24 onto base 26, bolting or any other method of connection that can withstand the temperatures in the particular system. Shroud 24 forms a cavity or chamber around servo valve 20 to contain a cooling air flow around servo valve 20. Cooling air enters inlet port 30, flows around cooling channel 34 and through flow passages 36. In the embodiment shown, base 26 includes four flow passages 36, but other embodiments can include more or less flow passages depending on cooling requirements. Base 26 also includes ports 40, 42, 43 for directing flow to actuator 18. Flow channel 34 is in an arcuate shape to channel cooling airflow to all flow passages and to cool the bottom of servo valve 20 (as in this embodiment, servo valve 20 is contained in a cylindrical housing). Flow passages 36 then deliver cooling airflow to shroud 24 to cool electrical components of servo valve 20. The cooling air in shroud 24 is vented through vent port 25 so that airflow stays continuous for adequate cooling of servo valve 20.

As discussed above, servo valve 20 controls valve 10 by regulating high temperature air delivered through supply port 42. Servo valve 20 meters this air in response to an electrical command and modulates the control pressure sent out through control port 40. The pressure in control port 40 triggers actuator to open or close valve disk by moving the pistons and/or linkage system to cause rotation of valve disk 16. The air going through control port 40 and supply port 42 is typically taken from valve passage 14. When valve is part of a gas turbine engine, and particularly part of a bleed system, the air is very hot, up to 1200 degrees F. (649 degrees C., 922.15). The electronic components in servo valve 20 are not able to withstand temperatures that hot, and are susceptible to melting, overheating and failure if exposed to the hot bleed air.

Cooling structure 22 acts to protect servo valve 20 from exposure to high temperatures, protecting electrical components without adding significant weight or additional components and without requiring extra space for valve 10. By containing servo valve 20 with shroud 24 and base 26 to form a small cavity around servo valve 20, cooling structure 22 can provide the cooling needed to protect electrical parts efficiently. This allows the placement of electrical components directly on or near valve 10, avoiding the extra space needed in past systems that located the electrical components away from valve 10 due to the high temperatures. This also provides for more efficient cooling than some past systems by containing the cooling airflow in a small area (in flow channel 34, flow passages 36 and within shroud 24), only where it is needed to provide cooling directly to only the parts needing it (electrical components).

While the cooling structure 22 has been described in relation to having an arcuate cooling channel 34 with four flow passages 36 into shroud 24, the cooling channel 34 and flow passages 36 can be shaped and/or sized differently according to cooling needs. Additionally, the system can have more or fewer cooling passages. While cooling structure 22 has been described in relation to cooling electrical components of a bleed valve, it could be used for cooling any components necessary in other valves used in other systems. Cooling structure 22 could also have different shapes and/or sizes depending on cooling needs of the valve.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A cooling structure for a servo valve, the structure comprising:
a shroud to enclose at least a portion of the servo valve; and
a base connected to the shroud to define a cooling chamber surrounding the servo valve, the base including an inlet port to receive cooling air, a flow channel connecting to the inlet port and a plurality of flow passages connecting the flow channel to the cooling chamber to allow cooling air flow from the inlet port into the cooling chamber.

2. The cooling structure of claim 1, and further comprising:
a vent port in the shroud to allow cooling air flow out of the shroud.

3. The cooling structure of claim 1, and further comprising:
an electrical connector on the base; and
electrical wires extending from the electrical connector to the servo valve through the base.

4. The cooling structure of claim 1, wherein the cooling structure is integral to the servo valve.

5. The cooling structure of claim 1, wherein the base is bolted to the servo valve.

6. The cooling structure of claim 1, wherein the base includes four flow passages.

7. The cooling structure of claim 1, wherein the flow channel is arcuate.

8. The cooling structure of claim 1, wherein the shroud covers a torque motor.

9. The cooling structure of claim 1, wherein the shroud is circular on top with cylindrical sides to form a cavity around at least a portion of the servo valve.

10. The cooling structure of claim 1, wherein the shroud is bolted to the base.

11. A valve for a bleed system, the valve including:
a valve body with a passageway;
a valve disk to regulate the flow of air through the valve passageway; and
a valve actuator to control the valve disk, wherein the valve actuator comprises:
a servo valve to control position of the valve disk in the passageway; and
a cooling air structure to enclose and cool the servo valve by circulating cool air past the servo valve.

12. The valve of claim 11, wherein the cooling structure comprises:
a shroud with a vent port; and
a base connecting to the shroud, with an inlet port to receive cooling air, a flow channel connecting to the inlet port and a flow passage connecting the flow channel to the shroud to allow cooling air flow into the shroud.

13. The valve of claim 12, wherein the cooling structure further comprises:
an electrical connector on the base to allow electrical connection wires to connect to the servo valve.

14. The valve of claim 12, wherein the shroud is circular on top with cylindrical sides to form a cavity around the servo valve.

15. The valve of claim 14, wherein the vent port is located on the top of the shroud.

16. The cooling structure of claim 12, wherein the base connects to the valve body.

17. The cooling structure of claim 12, and further comprising:
a plurality of flow passages connecting the flow channel to the shroud to allow cooling air flow into the shroud.

18. A method of cooling a portion of a servo valve with electrical components, the method comprising:
providing a servo valve with a portion with electrical components;
providing a cooling structure with a shroud with a vent port and a base, the base with an inlet port to receive cooling air, a flow channel connecting to the inlet port and a plurality of flow passages connecting the flow channel to the shroud to allow cooling air flow into the shroud;
connecting the base to the portion of the servo valve with electrical components; and
connecting the shroud to the base to form a cooling air cavity around the portion of the servo valve with electrical components.

19. The method of claim 18, and further comprising:
connecting the inlet port to a cooling air flow so that cooling air flows into the inlet port, around the flow channel, through the plurality of flow passages, into the shroud and out the vent port.
